(19) United States
(12) Patent Application Publication
(10) Pub. No.: US 2024/0323843 A1
(43) Pub. Date: Sep. 26, 2024

(54) LOW ENERGY SENSOR

(71) Applicant: Preddio Technologies Inc., North Andover, MA (US)

(72) Inventors: Aaron T. Ganick, Boxford, MA (US); Scott Kelly, Pelham, NH (US); Brian Rheaume, Westford, MA (US)

(21) Appl. No.: 18/187,293

(22) Filed: Mar. 21, 2023

(51) Int. Cl. H04W 52/02

(52) U.S. Cl. CPC H04W 52/0229; H04W 84/18

(57) ABSTRACT

A low energy sensor and method to implement thereof are provided. The sensor may be a Bluetooth Low Energy (BLE) compatible sensor. The sensor may include a processor coupled to a communicator and a memory. The processor may be configured to place the sensor in a listening mode such that while in the listening mode, the sensor does not transmit or broadcast any data unless the sensor receives a wake-up request. Upon receiving the wake-up request, the sensor may be configured to detect a first parameter, generate an advertisement packet including the first parameter, broadcast the advertisement packet, and broadcast the wake-up request to any additional devices or sensors that may be in a vicinity of the sensor.

### FIELD OF THE INVENTION

This disclosure generally relates to broadcasting data gathered by a sensor. Specifically, this disclosure relates to a sensor implementing a low energy method of broadcasting gathered data through an advertisement packet via the Bluetooth Low Energy protocol.

### BACKGROUND OF THE INVENTION

Various communication protocols exist for modern devices that form an Internet-of-Things (IoT), some of which include WiFi, Bluetooth, and Z-Wave.

Bluetooth Low Energy (BLE) or Bluetooth Smart is a newer technology that has been integrated to Bluetooth protocol since Bluetooth 4.0. In contrast to Classic Bluetooth, BLE is intended to provide reduce power consumption and cost while maintaining a similar communication range.

Devices that are not directed plugged into a power source have limited battery capacities, limiting the amount of power consuming functions that a particular device may perform before needing to replace or recharge its battery. Thus, power management and low power consumption are especially crucial for IoT devices that are typically battery powered.

Although BLE is already able to provide reduce power consumption as opposed to classic Bluetooth, it is not without flaws. In a typical BLE protocol, connection between two Bluetooth-enabled devices is a two-step process. First, a BLE peripheral device broadcasts within its broadcasting range an advertisement. The point of an advertisement is to notify Bluetooth-enabled devices (such as a mobile phone or a computer) within the proximity of the peripheral device that the peripheral device is available to communicate.

Next, if a Bluetooth-enabled device desires to communicate with the peripheral device, a connection may be established, whereby the peripheral device may transmit additional data to the Bluetooth-enabled device as appropriate.

Packet size of an advertisement packet is technically limited to 37 bytes in Bluetooth 4.0. However, an advertisement address (Bluetooth MAC Address) requires 6 bytes. Thus, actual payload size available in an advertisement packet is 31 bytes. As may be appreciated, 31 bytes is typically too small for substantive data transmission. The advertisement packet is meant for advertising to nearby devices what the broadcasting device is and what kind of services that broadcasting device may provide. Thereafter, addition information and data may be transmitted from the peripheral device upon a scan request from a requesting device or upon a successful connection. However, responding to a scan request or pairing with another device increases power consumption. Thus, there is a need to be able to transfer substantive information without having to first pair with a Bluetooth-enabled device.

Bluetooth 5.0 provides a functionality known as “advertising extensions” that extends the data size of a single advertisement packet from 37 bytes (as in Bluetooth 4.0) up to 255 bytes. However, such functionality is not backward compatible, meaning older devices that do not support Bluetooth 5.0 cannot discover extended advertisements. Thus, there is a need to utilize existing 31 bytes architecture to transmit substantive information without having to upgrade legacy devices to be Bluetooth 5.0 compatible.

In contrast to a typical Bluetooth device, a beacon is a special subset of BLE devices that is limited in functionalities. Specifically, a beacon uses only advertising mode to broadcast data to all the devices within its range. There is no ability to connect with a beacon. That is to say a beacon may only transmit data but not receive data. Further, the information broadcasted from a beacon is usually predetermined. For example, a beacon is typically configured to broadcast its own ID. A Bluetooth-enabled device in proximity of the beacon would receive this beacon ID and may recognize the received beacon ID by connecting to an online database. Once the Bluetooth-enabled device recognize the received beacon ID, it may be determined that the Bluetooth-enabled device is physically near the beacon, thus additional functionalities may be transmitted from an online server to the Bluetooth-enabled device such as location positioning or targeted marketing. In this sense, a beacon essentially functions as a location marker. It may only transmit data unilaterally without being paired for further configurations or communications. Thus, a beacon is generally not suitable for complex functionalities provided by a traditional Bluetooth device.

### SUMMARY OF THE INVENTION

A first aspect of this disclosure pertains to a method for low energy sensing comprising: placing a sensor in a listening mode; receiving, by the sensor, a wake-up request; in response to the sensor receiving the wake-up request: detecting, by the sensor, a first parameter; generating, by the sensor, a first packet including the first parameter; and broadcasting, by the sensor, the first packet.

A second aspect of this disclosure pertains to the method of the first aspect, wherein while in the listening mode, the sensor is configured to not transmit any data unless the wake-up request is first received.

A third aspect of this disclosure pertains to the method of the first aspect, wherein while in the listening mode, the sensor is configured to not detect any parameter unless the wake-up request is first received.

A fourth aspect of this disclosure pertains to the method of the first aspect further comprising: in response to the sensor receiving the wake-up request, broadcasting, by the sensor, the wake-up request.

A fifth aspect of this disclosure pertains to the method of the first aspect, wherein the sensor is Bluetooth Low Energy (BLE) compatible, and the first packet is an advertisement packet.

A sixth aspect of this disclosure pertains to the method of the first aspect, wherein prior to the sensor receiving the wake-up request, the sensor has no other communication with a device that transmitted the wake-up request.

A seventh aspect of this disclosure pertains to the method of the first aspect further comprising: in response to the sensor receiving the wake-up request, detecting, by the sensor, a second parameter, wherein the first parameter is different from the second parameter.

An eighth aspect of this disclosure pertains to the method of the seventh aspect, wherein the first packet includes both the first parameter and the second parameter.

A ninth aspect of this disclosure pertains to the method of the seventh aspect, further comprising: in response to the sensor receiving the wake-up request: generating, by the sensor, a second packet including the second parameter; and broadcasting, by the sensor, the second packet.

A tenth aspect of this disclosure pertains to a method for low energy sensing comprising: placing a sensor in a listening mode; detecting, by the sensor, a first parameter; storing, by the sensor, the first parameter; receiving, by the sensor, a wake-up request; in response to the sensor receiving the wake-up request: generating, by the sensor, a first packet including the stored first parameter; and broadcasting, by the sensor, the first packet.

An eleventh aspect of this disclosure pertains to the method of the tenth aspect, wherein while in the listening mode, the sensor is configured to not transmit any data unless the wake-up request is first received.

A twelfth aspect of this disclosure pertains to the method of the tenth aspect further comprising: in response to the sensor receiving the wake-up request, broadcasting, by the sensor, the wake-up request.

A thirteenth aspect of this disclosure pertains to the method of the tenth aspect, wherein the sensor is Bluetooth Low Energy (BLE) compatible, and the first packet is an advertisement packet.

A fourteenth aspect of this disclosure pertains to the method of the tenth aspect, wherein prior to the sensor receiving the wake-up request, the sensor has no other communication with a device that transmitted the wake-up request.

A fifteenth aspect of this disclosure pertains to the method of the tenth aspect further comprising: detecting, by the sensor, a second parameter, wherein the first parameter is different from the second parameter; and storing, by the sensor, the second parameter.

A sixteenth aspect of this disclosure pertains to the method of the fifteenth aspect, wherein the first packet includes both the stored first parameter and the stored second parameter.

A seventeenth aspect of this disclosure pertains to the method of the fifteenth aspect further comprising: in response to the sensor receiving the wake-up request: generating, by the sensor, a second packet including the second parameter; and broadcasting, by the sensor, the second packet.

An eighteenth aspect of this disclosure pertains to a Bluetooth Low Energy (BLE) sensor comprising: a processor coupled to a communicator, the processor is configured to place the BLE sensor in a listening mode; the communicator is configured to receive a wake-up request; in response to the communicator receiving the wake-up request: the processor is further configured to: detect a first parameter; and generate a first advertisement packet including the first parameter; the communicator is further configured to: broadcast the first advertisement packet; and broadcast the wake-up request.

A nineteenth aspect of this disclosure pertains to the BLE sensor of the eighteenth aspect, wherein while in the listening mode, the communicator is configured to not transmit any data unless the wake-up request is first received

A twentieth aspect of this disclosure pertains to the BLE sensor of the eighteenth aspect, wherein the processor is further configured to detect a second parameter, wherein the second parameter is different from the first parameter, and wherein the first advertisement packet includes both the first parameter and the second parameter.

### BRIEF DESCRIPTION OF THE DRAWINGS

FIG. 1 illustrates a system of Bluetooth-enabled devices according to an example embodiment.

FIG. 2 illustrates a 31-byte advertisement packet (excluding MAC address) according to an example embodiment.

FIG. 3 illustrates an example scheme for dynamically broadcasting data using the advertisement packet shown in FIG. 2.

FIG. 4 illustrates a first detailed scheme of an advertisement packet according to an example embodiment.

FIG. 5 illustrates a second detailed scheme of an advertisement packet according to an example embodiment.

FIG. 6 illustrates a BLE device according to an example embodiment.

FIG. 7 illustrates a process for detecting and broadcasting data according to an example embodiment.

Before explaining the disclosed embodiment of the present invention in detail, it is to be understood that the invention is not limited in its application to the details of the particular arrangement shown, since the invention is capable of other embodiments. Example embodiments are illustrated in the referenced figures of the drawings. It is intended that the embodiments and figures disclosed herein are to be considered illustrative rather than limiting. Also, the terminology used herein is for the purpose of description and not of limitation.

### DETAILED DESCRIPTION

Although this invention is susceptible of embodiments in many different forms, there are shown in the drawings and are described in detail herein specific embodiments with the understanding that the present disclosure is an exemplification of the principles of the invention. It is not intended to limit the invention to the specific illustrated embodiments. The features of the invention disclosed herein in the description, drawings, and claims may be significant, both individually and in desired combinations, for the operation of the invention in its various embodiments. Features from one embodiment may be used in other embodiments of the invention.

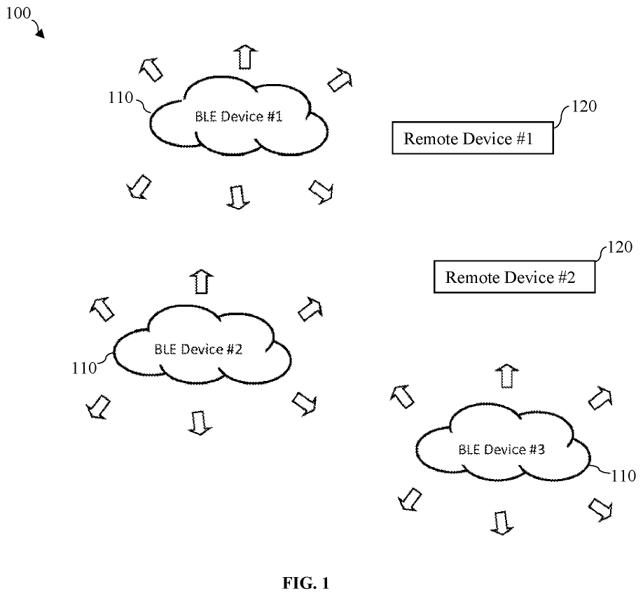

Referring to FIG. 1, a system 100 of Bluetooth-enabled devices is illustrated. The system 100 may include one or more BLE devices 110 and one or more remote devices 120. The BLE devices 110 may be Bluetooth 4.0 compatible devices that may be capable of both an advertising mode and a connection mode. That is to say, the BLE devices 110 may be non-beacon devices that may broadcast advertisement packets periodically until one of the remote devices 120 requests to make a connection. Then, the BLE devices 110 may be connected or paired with one or more of the remote devices 120 as appropriate. However, the system 100 may also include one or more beacon devices, any number of BLE devices, and any number of remote devices.

In a master/slave scheme, the remote device 120 or a master device may be a mobile phone, a tablet, a computer, or other Bluetooth-enabled devices. Whereas the BLE device 110 or a slave device may be a sensor, a smart watch, a Bluetooth headset, or the like. Although Bluetooth protocol allows master and slave relationship to be switched, for the ease of understanding, for ease of reference herein, it is to be understood that master devices refer to devices such as Bluetooth-enabled mobile phones and computers, whereas slave devices refer to devices such as sensors.

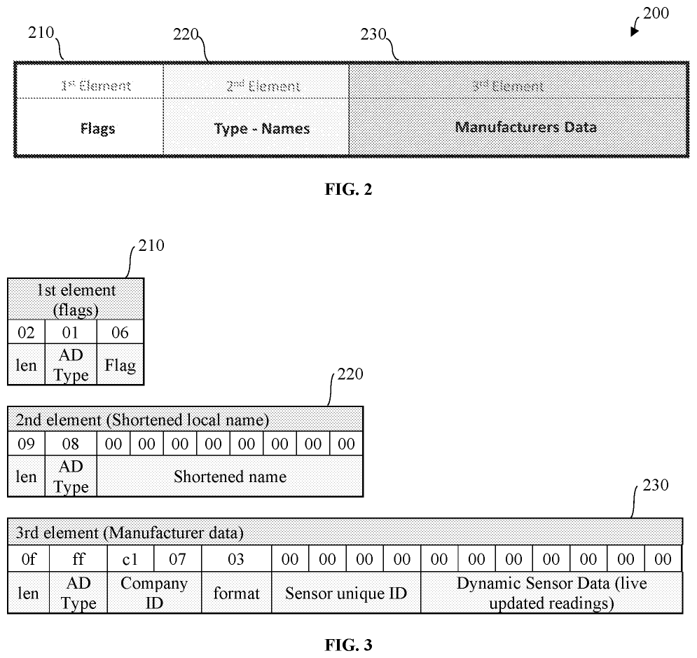

In advertising mode, each of the BLE device 110 may periodically broadcast a Bluetooth 4.0 compatible advertisement packet, i.e., a 31 bytes packet and a 6 bytes MAC address, totaling 37 bytes. An example advertisement packet is shown in FIG. 2. As shown in FIG. 2, an advertisement packet 200 may be defined into three elements. A first element 210 for flags, a second element 220 for type and names, and a third element 230 for manufacturer data (Manufacturer-Specific Data).

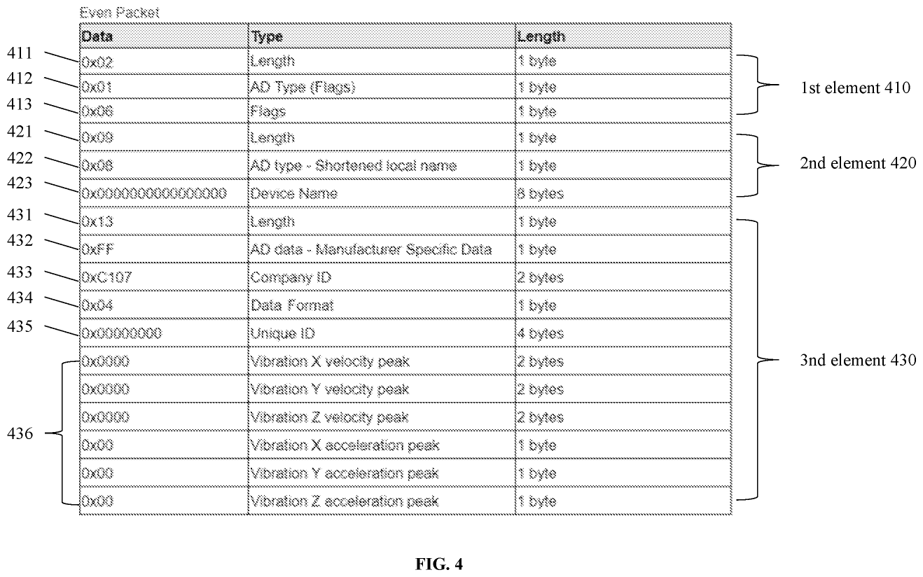

FIG. 3 illustrates each of the elements aforementioned in more details according to an example embodiment. The first element 210 may contain the flags that are standardized and defined in various Bluetooth standard documents. The second element 220 and the third element 230 may be customized to enable dynamic broadcasting of Bluetooth data.

Specifically, the second element 220 may be modified to rename a device while maintaining a unique ID. In addition, the third element 230 may be modified to provide the unique ID and associated dynamic data in a compressed format as shown in FIG. 3, thereby enabling maximum data amounts of data transfer. The unique ID may be a unique number assigned during the manufacturing of BLE devices so that every BLE device manufactured has a different unique ID. In addition, the advertisement packet 200 may be enhanced with the notion of ‘odd’ and ‘even’ packets which contain different information. This additional information allows scalability of the amount of data that may be reliably transmitted.

FIG. 4 illustrates as a scheme of a dynamic data according to an example embodiment. The first element 410 may comprise a first length 411, a first AD type 412—corresponding to a flags, and flags 413, each accounting for one byte of data. The second element 420 may comprise a second length 421, a second AD type 422—corresponding to a shortened local name, and a device name 423, with the second length 421 and the second AD type 422 each accounting for one byte of data, and the shorten device name 423 accounting for eight bytes of data. The third element 430 may comprise a third length 431, a third AD data 432—corresponding to a manufacturer specific data, a company ID 433, a data format 434, a unique ID 435, as well as allocations for data being broadcasted 436. As shown in FIG. 4, the third length 431, the third AD data 432, and the data format 434 may each account for one byte of data; the company ID 433 may account for two bytes of data, and the unique ID 435 may account for four bytes of data. Following the scheme sets for in FIG. 4, up to nine bytes may be used to broadcast dynamic data within a 31 bytes advertisement packet (not account for MAC address).

By way of example, according to an embodiment, a BLE device may be a sensor that is configured to broadcast data according to the scheme set forth herein. For the purpose of illustration, the sensor may be configured to detect environmental parameters such as vibration, velocity, acceleration, temperature, pressure, or the like; device parameters such as operational status, battery level, connection status, or the like; as well as additional parameters as appropriate.

Referring back to FIG. 4, when the sensor is configured to broadcast data based on the scheme described, two bytes each may be allocated for axis x, y, and z vibration velocity peaks, and one byte each may be allocated for axis x, y, and z vibration acceleration peaks. As may be appreciated, these remaining bytes may be used to broadcast other types of substantive data collected by the sensor. That is to say, these bytes are not limited to only broadcasting vibration related data, instead, the remaining nine bytes may be used to broadcast one or more types of sensor data that combined take up to nine-bytes. For example, the remaining nine bytes may be used to broadcast a first sensor data that is nine-bytes long. The remaining nine bytes may also be used to broadcast a second and a third sensor data that are four bytes each, or four and five bytes each, or any other possible combinations as appropriate. In yet another example, the remaining nine-bytes may be used to broadcast nine different types of sensor data, each accounting for one byte.

Further still, the unique ID need not be fixed at four bytes. In an embodiment, the unique ID may be less than four bytes such as three bites, thus allowing up to ten bytes of sensor data. In yet another embodiment, the unique ID may be more than four bytes such as five bytes, thus allowing up to eight bytes of sensor data. That is to say, the length of the unique ID and the length of bytes available for sensor data may be adjusted as necessary. Put simply, up to 13 bytes may be made available for the unique ID and the sensor data. Other modifications to the advertisement packet may also be used, such as eliminating certain elements altogether.

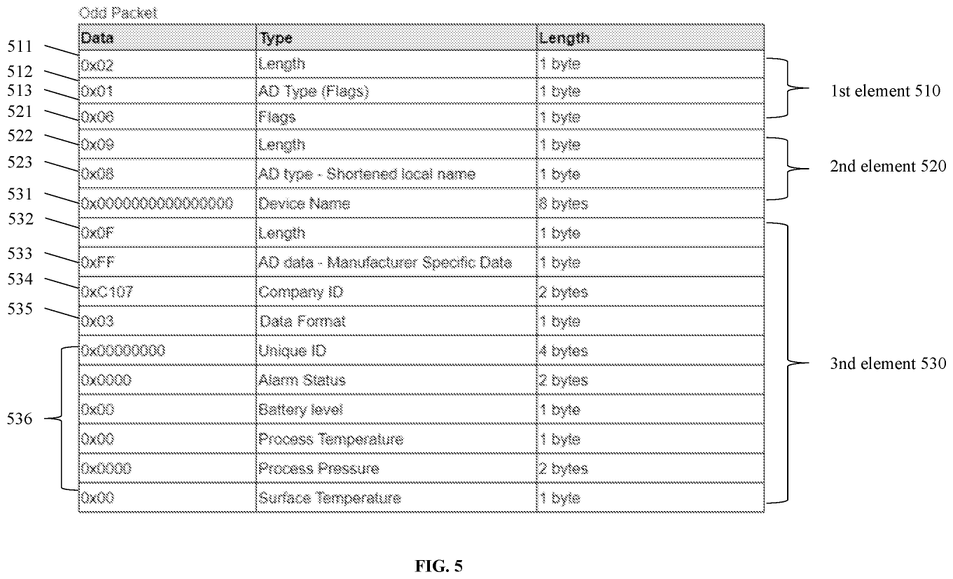

In addition, odd and even schemes may be employed to broadcast data containing different substantive information. Continuing the example from above, the sensor may gather additional parameters not already broadcasted in the advertisement packet shown in FIG. 4. Thus, an additional advertisement packet may be broadcasted as shown in FIG. 5. For the purpose of simplicity, the advertisement packet according to FIG. 4 is herein referred to as an even packet (or a first packet), and the advertisement packet according to FIG. 5 is herein referred to as an odd packet (or a second packet).

Referring to FIG. 5, the first 22 bytes of the odd packet are generally the same as the even packet of FIG. 4. That is to say, the odd packet also comprises a first element 510, a second element 520, and a third element 530. Again, the first element 510 may comprise a first length 511, a first AD type 412—corresponding to a flags, and flags 513, each accounting for one byte of data. The second element 520 may comprise a second length 521, a second AD type 522—corresponding to a shortened local name, and a device name 523, with the second length 521 and the second AD type 522 each accounting for one byte of data, and the shorten device name 523 accounting for eight bytes of data. The third element 530 may comprise a third length 531, a third AD data 532—corresponding to a manufacturer specific data, a company ID 533, a data format 534, a unique ID 535, as well as allocations for data being broadcasted 536.

Unlike the even packet however, the odd packet may comprise other substantive information gathered by the sensor that are not already broadcasted within the even packet. By way of example, according to an embodiment, the odd packet may comprise alarm status (accounting for two bytes), battery level, process temperature, and surface temperature, each accounting for one byte, and process pressure accounting for two bytes of data. As may be appreciated, in this example, the total packet size is only 29 bytes, meaning two additional bytes is available for use in a 31 bytes advertisement packet.

The switch between broadcasting even packet and broadcasting odd packet may be based on advertising interval of the sensor or the broadcasting device where the two packets may be alternatively broadcasted. For example, the sensor may be configured to broadcast the even packet at time t, and the odd packet at time t+1. Thereafter, the even packet may be broadcasted at t+2 and the odd packet may again be broadcasted at t+3 and so forth. The advertising interval may be determined based on a desired battery life of the broadcasting device, as shorter interval translates into shorter battery life. In an embodiment, the advertising internal may be between 100 milliseconds (ms) to 1000 ms.

Since the packets alternate based on the advertising interval, this eliminates the need of the BLE device to wait for a scan request to transmit additional information. That is to say, the BLE device may be configured to alternate broadcasting an even packet and an odd packet without the need to wait for a scan request from a remote device and without using a scan response packet.

Although only two advertisement packets are described—an odd packet and an even packet-additional advertisement packets may also be dynamically broadcasted using similar schemes. For example, a BLE device may be configured to broadcast a first advertisement packet, a second advertisement packet, and a third advertisement packet, each comprising different parameters gathered by a sensor.

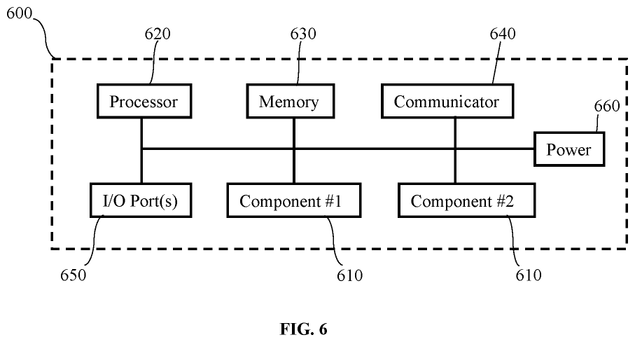

The data being transmitted using the schemes described herein need not all be gathered by a single sensor. In an embodiment, as shown in FIG. 6, a device 600 (such as a BLE compatible sensor, the BLE device 110, or other compatible devices or the like) may include one or more components 610. The components may be sensors such as accelerometers, speedometers, pressure gauges, current sensors, voltage sensors, temperature gauges, motion detectors, proximity sensors, hall effect sensors, light sensors, or any other types of sensors. In addition, the components 610 may be a light, where data being transmitted according to the schemes may be whether the light is on or off or its brightness level. The components 610 may also be various types of switches such as those used in a control system or in manufacturing plants. Certainly, the components 610 may also be devices from residential settings in addition to industrial settings. The principal in applying the schemes is generally similar, where the data being transmitted may correspond to a status of one or more components (such as one light on or all lights on), a parameter of one or more components (such as a brightness of a lightbulb), or a parameter detected or gathered by one or more components (such as temperature, pressure, accelerations).

The device 600 utilizing the schemes described herein may include a processor 620 coupled to a memory 630 (such as a hard drive and/or a random-access memory (RAM)) and a communicator 640. The communicator 640 may be Bluetooth-enabled and may be a two-way transceiver, a one-way transmitter, or other Bluetooth-enable communication modules. The processor 620 may further be coupled to one or more components 610 as aforementioned. Software or algorisms stored on the memory 630 may cause the processor 620 to encode and to generate advertisement packets comprising data from the one or more components 610 according to the dynamic broadcasting schemes and broadcasts the advertisement packets via the communicator 640. Certainly, the device 600 may include additional modules such as an input/output (I/O) port 650 (such as buttons, switches, actuators, Universal Serial Bus (USB) ports, or other suitable I/O), a power source 660 such as a battery, a plug, or other types or power supply, or other modules as applicable.

Moreover, the dynamic data being broadcasted via advertisement packets need not all come from a same device or sensor. For example, referring back to FIG. 1, in embodiments where the system 100 is configured as a meshed network setup, gathered information from a first BLE device 110 may be transmitted to a second BLE device 110, where the second BLE device 110 may then broadcast advertisement packets comprising information gathered by the first BLE device 110 as well as information gathered by the second BLE device 110 using the schemes aforementioned.

A remote device 120 may be configured to receive advertisement packet(s) broadcasted from one or more BLE devices 110. An application or a software installed on the remote device 120 may be used to interpret the advertisement packets received. Alternatively or in addition, the remote device 120 may be configured to forward the received advertisement packets to one or more servers and/or one or more additional remote devices 120 for further processing.

In some embodiments, the BLE device 110 may be capable of two-way communication instead of unitary one-way transmission of information. The remote device 120 may be configured to paired with one or more BLE devices 110, enabling the remote device 120 to monitor and/or configure each of the paired BLE devices 110. This is known as a connection mode or a communication mode as opposed to advertisement mode.

In the connection mode, a pairing request may be transmitted and a connection may be established. For example, if a BLE device 110 is a sensor, a remote device 120 such as a mobile phone or a computer may be paired with the sensor to adjust the sensor's functionalities. In an embodiment, one of the functionalities that may be adjusted may be the parameters being broadcasted in one or more advertisement packets by the sensor. Likewise, an advertisement interval may be another functionality adjustable after being paired with the remote device 120.

In short, a BLE device 110 may be configured to broadcast data gathered by the BLE device 110 via one or more advertisement packets according to the schemes described herein. Thereafter, when desired, a remote device 120 may be paired the BLE device to perform additional functions such as to retrieve historical data gathered or to configure the BLE device.

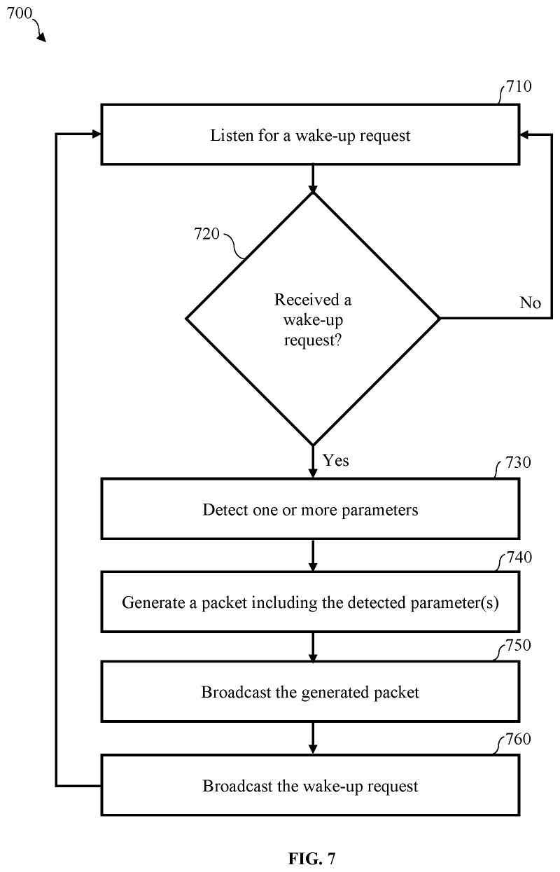

In some circumstances, it may be desirable to minimize power consumption of a sensor (such as the device 600 described above). Referring to FIG. 7, a process 700 for detecting and broadcasting data is illustrated. The process 700 may be performed by the sensor through executing a software stored in a memory with a processor on the sensor. Alternatively or additionally, the process 700 may be implemented through a programmable logic controller or other suitable means.

At step 710, the sensor may initially be configured to be in a listening mode, a standby mode, or a “sleep” mode. In some embodiments, the sensor may include additional modes, but may be placed in the listening mode automatically and/or manually. For example, the sensor may have a default mode that regularly advertises parameters detected by the sensor via one or more advertisement packets described above. However, when a battery level of the sensor is below a certain threshold, the sensor may be configured to automatically switch to the listening mode. In another example, the listening mode may be the default mode for the sensor where said sensor may or may not include additional modes.

While the sensor is in the listening mode, the sensor may be configured such that the sensor does not broadcast or transmit any data-including advertisement packets—i.e., the sensor is silent during the listening mode. Thus, while the sensor is in the listening mode, the sensor may further reduce power consumption by eliminating outgoing transmissions.

At step 720, the sensor may check for a “wake-up” request. The wake-up request may be transmitted by a remote device (such as a mobile phone, a tablet, a computer, or the like) or by another sensor or other devices. Because the sensor has been in the listening mode, the sensor has not been transmitting data. Therefore, the remote device may not be aware whether any sensor is within the remote device's vicinity. Therefore, the remote device may broadcast the wake-up request blindly, without knowing whether any sensor is listening or what types of sensors may be listening, if any. Put differently, the remote device may broadcast the wake-up request without having prior communication with any sensor.

Of course, simply because the remote device may not be aware of the sensor's existence or location may not preclude a user of the remote device from knowing where the user may locate one or more sensors. By way of example, one or more sensors may be placed on or near a production line in a factory to monitor the production line. Here, although the remote device may not be aware that any sensor is within the remote device's vicinity, the user may have a general knowledge that the production line is equipped with sensors. Thus, the user may control the remote device to broadcast the wake-up request even if the remote device is blind as to the existence of the sensors.

At step 720, if the sensor does not receive a wake-up request, the sensor may be configured to return to step 710 and continue to listen for a wake-up request. The sensor may be configured to check for the wake-up request continuously, periodically, or on-demand. Because the sensor may be configured to do nothing except to listen for a wake-up request while in the listening mode, the sensor may be deemed an on-demand sensor.

In some embodiments, one or more means to exit the sensor out of the listening mode without a wake-up request may be provide. For example, the sensor may include a button (or a switch or other suitable actuators) such that when pressed, the sensor is configured to switch between the listening mode and another mode. In another example, the button may turn the sensor on or off, where the sensor is configured to default to the listening mode when on. In further embodiments, the sensor may be configured such that no telecommunication may exit the sensor out of the listening mode except for receiving a wake-up signal, but when the sensor is hardwired (i.e., plugged in) to an external device, the sensor may be placed in other modes such as a diagnostic mode.

If the sensor receives a wake-up request, the sensor may proceed to step 730 where the sensor may be configured to detect one or more parameters. For example, a vibration sensor may be configured to detect a vibration value, a humidity sensor may be configured to detect a humidity value, a status indicator may be configured to detect whether a machine is on or off or other relevant statuses, or the like. If the sensor is capable of detecting multiple parameters, the sensor may be configured to detect some or all of the parameters that the sensor is capable of detecting at step 730.

In some embodiments, to maximize power conservation, while the sensor is in the listening mode, the sensor may be configured to not detect or gather any data until the sensor receives a wake-up request.

In other embodiments, the sensor may periodically detect or gather parameters even while in the listening mode. In such embodiments, the sensor may be configured to store some or all of the parameters detected in a memory (such as a hard drive) onboard the sensor. Depending on the capacity of the memory, the sensor may be configured to store some or all of the parameters detected. If the capacity is limited or if the memory reaches capacity, the sensor may overwrite the oldest parameter detected with the newest parameter detected.

For example, the memory of the sensor may be configured to store up to eight (8) data points. In this example, the sensor may be configured to periodically detect a parameter (such as velocity, acceleration, vibration, temperature, pressure, device status, etc) and store the detected parameter in the memory. Once the memory is at capacity, the parameter currently detected (time t) may overwrite the parameter detected eight (8) periods ago (time t−8). Thus, the sensor may be configured to store the parameter detected at up to eight (8) different time points.

In another example, the memory of the sensor may also be configured to store up to eight (8) data points. However, in this example, the sensor may be capable of detecting four (4) different types of parameters. In this example, the memory may be configured to store all four (4) types of parameters at up to two (2) different time points. As can be appreciated, other variations are also possible and are within the spirit of this disclosure.

In embodiments where the sensor is configured to periodically detect parameters even while in the listening mode, at step 730, the sensor may be configured to detect one or more parameters upon receiving the wake-up request without waiting until the next time period. In further embodiments, step 730 may be omitted.

At step 740, the sensor may be configured to generate a packet including the parameter detected. In some embodiments, the packet generated may be an advertisement packet using the scheme described previously. How many advertisement packets may be generated by the sensor may depend on how many parameters the sensor is capable of detecting.

Using the scheme shown in FIG. 4 as an example, the sensor may be capable of detecting both velocity and acceleration. In this case, at step 740, the sensor may be configured to generate an advertisement packet including both velocity and acceleration. However, the sensor may also be capable of detecting temperature and pressure. Because one advertisement packet may not be able to contain all four parameters (velocity, acceleration, temperature, and pressure), the sensor may be configured to generate two advertisement packets instead, with a first advertisement packet including some parameters (such as velocity and acceleration) and a second advertisement packet including other parameters (such as temperature and pressure). As can be appreciated, if the sensor is capable of detecting more parameters, the sensor may be configured to generate even more advertisement packets.

In embodiments where the sensor is configured to store multiple data points, such as for parameter(s) at different times, at step 740, the sensor may be configured to generate an adequate amount of advertisement packets to transmit all the data points stored. For example, if the memory of the sensor has eight data points of parameters stored thereon, and each advertisement packet may only include up to two parameters, the sensor may be configured to generate four advertisement packets, each including one or more parameters stored in the memory.

At step 750, the packet generated at step 740 may be broadcasted. If only one packet is generated at step 740, the sensor may be configured to broadcast said packet only once. Alternatively, the sensor may be configured to repeatedly and/or periodically broadcast said packet for a fixed time period (such as for 5 seconds).

In embodiments where multiple packets are generated, the sensor may be configured to broadcast some or all of the multiple packets at step 750 (such as sequentially, alternatively, or randomly), or the sensor may be configured to repeat step 740 and step 750 such that one packet is generated and broadcasted before a next packet is generated and broadcasted.

At step 760, the sensor may be configured to broadcast or relay the wake-up request to nearby sensors that may be out-of-range of the remote device that originated the wake-up request (i.e., the originator). Such a setup is different from a meshed network in that each device operates independently of one another regardless of how many sensors may be in a vicinity. Because each sensor is in the listening mode, the sensors are not interconnected to one another. The only interaction between the sensors is when one sensor blindly broadcast the wake-up request, and another sensor receives the wake-up request while in the listening mode. Such configuration may reduce network complexity and may be implemented with only one sensor or with multiple sensors.

Thereafter, the sensor may return to step 710 and continue to listen for a next wake-up request. In some implementations, a delay may be included to prevent an echoing effect due to additional wake-up requests being broadcasted by nearby sensors. For example, once the sensor broadcasts the packet including the parameter(s) detected, the sensor may be configured to wait a time period (such as 10 seconds or 1 minute) before returning to the listening mode. Alternatively or additionally, the wake-up request may include an originator information such that the sensor may only react to a fixed amount of wake-up request from one originator within a time period.

Unlike a standard sensor configuration, in implementing the process 700, the sensor may not need to establish a pairing connection with the remote device in order to transmit parameter values gathered by the sensor. Indeed, the remote device may not be aware that any sensor is within the remote device's vicinity, thus the wake-up request may be broadcasted blindly. Likewise, the sensor may be configured to generate the packet and broadcast the packet blindly such that the packet may or may not be received by the remote device, or that the packet may be received by other or additional remote devices that are not the originator of the wake-up request. Again, such a configuration may reduce network complexity, cost, and may be more power efficient. In further embodiments, a pairing connection may be established (i.e., paired) between the sensor and the remote device in addition to the method described in the process 700.

Other variations of the process 700 are also contemplated herein. For example, the process 700 may include additional step(s), or certain step(s) may be omitted. Likewise, orders of performing the steps may vary and are within the spirit of this disclose.

Specific embodiments of a low energy sensor according to the present invention have been described for the purpose of illustrating the manner in which the invention may be made and used. It should be understood that the implementation of other variations and modifications of this invention and its different aspects will be apparent to one skilled in the art, and that this invention is not limited by the specific embodiments described. Features described in one embodiment may be implemented in other embodiments. The subject disclosure is understood to encompass the present invention and any and all modifications, variations, or equivalents that fall within the spirit and scope of the basic underlying principles disclosed and claimed herein.

What is claimed is:

1. A method for low energy sensing comprising:
placing a sensor in a listening mode;
receiving, by the sensor, a wake-up request;
in response to the sensor receiving the wake-up request:
detecting, by the sensor, a first parameter;
generating, by the sensor, a first packet including the first parameter; and
broadcasting, by the sensor, the first packet.

2. The method of claim 1, wherein while in the listening mode, the sensor is configured to not transmit any data unless the wake-up request is first received.

3. The method of claim 1, wherein while in the listening mode, the sensor is configured to not detect any parameter unless the wake-up request is first received.

4. The method of claim 1 further comprising:
in response to the sensor receiving the wake-up request, broadcasting, by the sensor, the wake-up request.

5. The method of claim 1, wherein the sensor is Bluetooth Low Energy (BLE) compatible, and the first packet is an advertisement packet.

6. The method of claim 1, wherein prior to the sensor receiving the wake-up request, the sensor has no other communication with a device that transmitted the wake-up request.

7. The method of claim 1 further comprising:
in response to the sensor receiving the wake-up request, detecting, by the sensor, a second parameter, wherein the first parameter is different from the second parameter.

8. The method of claim 7, wherein the first packet includes both the first parameter and the second parameter.

9. The method of claim 7 further comprising:
in response to the sensor receiving the wake-up request:
generating, by the sensor, a second packet including the second parameter; and
broadcasting, by the sensor, the second packet.

10. A method for low energy sensing comprising:
placing a sensor in a listening mode;
detecting, by the sensor, a first parameter;
storing, by the sensor, the first parameter;
receiving, by the sensor, a wake-up request;
in response to the sensor receiving the wake-up request:
generating, by the sensor, a first packet including the stored first parameter; and
broadcasting, by the sensor, the first packet.

11. The method of claim 10, wherein while in the listening mode, the sensor is configured to not transmit any data unless the wake-up request is first received.

12. The method of claim 10 further comprising:
in response to the sensor receiving the wake-up request, broadcasting, by the sensor, the wake-up request.

13. The method of claim 10, wherein the sensor is Bluetooth Low Energy (BLE) compatible, and the first packet is an advertisement packet.

14. The method of claim 10, wherein prior to the sensor receiving the wake-up request, the sensor has no other communication with a device that transmitted the wake-up request.

15. The method of claim 10 further comprising:
detecting, by the sensor, a second parameter, wherein the first parameter is different from the second parameter; and
storing, by the sensor, the second parameter.

16. The method of claim 15, wherein the first packet includes both the stored first parameter and the stored second parameter.

17. The method of claim 15, further comprising:
in response to the sensor receiving the wake-up request:
generating, by the sensor, a second packet including the second parameter; and
broadcasting, by the sensor, the second packet.

18. A Bluetooth Low Energy (BLE) sensor comprising:
a processor coupled to a communicator, the processor is configured to place the BLE sensor in a listening mode;
the communicator is configured to receive a wake-up request;
in response to the communicator receiving the wake-up request:
the processor is further configured to:
detect a first parameter; and
generate a first advertisement packet including the first parameter;
the communicator is further configured to:
broadcast the first advertisement packet; and
broadcast the wake-up request.

19. The BLE sensor of claim 18, wherein while in the listening mode, the communicator is configured to not transmit any data unless the wake-up request is first received.

20. The BLE sensor of claim 18, wherein the processor is further configured to detect a second parameter, wherein the second parameter is different from the first parameter, and
wherein the first advertisement packet includes both the first parameter and the second parameter.
